(19) United States
(12) Patent Application Publication
(10) Pub. No.: US 2026/0087019 A1
(43) Pub. Date: Mar. 26, 2026

(54) METHOD AND APPARATUS FOR PERSONALIZATION OF GENERATIVE LANGUAGE MODEL

(71) Applicant: ELECTRONICS AND TELECOMMUNICATIONS RESEARCH INSTITUTE, Daejeon (KR)

(72) Inventors: Jeong HEO, Daejeon (KR); Oh Woog KWON, Daejeon (KR); Jihee RYU, Daejeon (KR); Young-Ae SEO, Daejeon (KR); Jin SEONG, Daejeon (KR); Jong Hun SHIN, Daejeon (KR); Ki Young LEE, Daejeon (KR); Soojong LIM, Daejeon (KR)

(73) Assignee: ELECTRONICS AND TELECOMMUNICATIONS RESEARCH INSTITUTE, Daejeon (KR)

(21) Appl. No.: 19/016,204

(22) Filed: Jan. 10, 2025

(30) Foreign Application Priority Data
Sep. 20, 2024 (KR) 10-2024-0127564

(51) Int. Cl. G06F 16/2457; G06F 16/2452

(52) U.S. Cl. CPC G06F 16/2457; G06F 16/24522

(57) ABSTRACT

Disclosed are a method and apparatus for generating personalized information using a generative language model and presenting generated results that suit a user based on the generated personalized information. An apparatus for personalization of a generative language model includes: a personalized information memory that stores personalized information of a user; and a personalized query generation unit that generates a personalized query prompt including personalized information from a user query input by the user using the personalized information stored in the personalized information memory. In an embodiment, the apparatus may further include a latest result memory that stores a question-response pair for a predetermined period, and a personalized information extraction unit that extracts information utilized as the personalized information from the question-response pair stored in the latest result memory and stores the extracted information in the personalized information memory.

### CROSS-REFERENCE TO RELATED APPLICATION(S)

This application claims priority from and the benefit of Korean Patent Application No. 10-2024-0127564, filed on Sep. 20, 2024, which is hereby incorporated by reference for all purposes as if set forth herein.

### BACKGROUND

### 1. Field

The present disclosure relates to a method and apparatus for personalization of a generative language model.

### 2. Description of Related Art

With the development of super-large language models, a generative artificial intelligence technology is rapidly developing. A generative language model technology is a technology that generates appropriate responses to users'questions or requests, and is developing rapidly along with the development of neural network architecture and hardware for parallel processing. However, generative language models are based on a huge amount of training data and expensive equipment, so it takes a lot of money and time to create a language model. This problem makes it difficult to build an artificial intelligence generative model that suits situations and preferences of individuals or specific organizations. Recently, super-large generative language models have been announced, mainly by big tech companies, and these models are showing excellent performance in various tasks. Most of the super-large generative language models may be used by utilizing APIs. In other words, the generative language models are black boxes. In addition, even the generative language models that are released require a lot of money to be fine-tuned to suit usage domains (or tasks).

Due to such problems, etc., in-context learning (hereinafter referred to as “ICL”) has been actively researched to effectively derive knowledge from pretrained LMs. The ICL is a technology that guides users to correctly generate results for questions they ask by presenting instructions and examples when they query a generative language model.

The generative language models have been generally used to generate results in a conversational format with users. When users ask a question, results are presented, and when additional questions are asked about the results, the results for the additional questions are presented by referring to previous questions and results. This conversational method is based on the history information within a conversation session that takes place within a unit time. Therefore, there is a disadvantage in that the results based on the conversation that take place in the previous session may not be presented.

These disadvantages ultimately means that personalized generated results utilizing the user's preferences or personalized information cannot be presented based only on the conversation history within the session. In addition, technologies for the generative language models to present the personalized generated results are not currently being actively researched.

### SUMMARY

The present disclosure provides an artificial intelligence technology capable of generating personalized information using a generative language model and present generated results that suit users based on this generated personalized information.

According to an embodiment of the present disclosure, an apparatus for personalization of a generative language model includes: a personalized information memory that stores personalized information of a user; and a personalized query generation unit that generates a personalized query prompt including personalized information from a user query input by the user using the personalized information stored in the personalized information memory.

The apparatus may further include: a latest result memory that stores a question-response pair for a predetermined period; and a personalized information extraction unit that extracts information utilized as the personalized information from the question-response pair stored in the latest result memory and stores the extracted information in the personalized information memory.

The personalized information extraction unit may generate a personalized information extraction prompt requesting to extract the personalized information of the user based on information on a session conversation at predetermined cycles, input the personalized information extraction prompt into the generative language model, and store the response of the generative language model in the personalized information memory as a personalized information template of the corresponding cycle.

The personalized information extraction prompt may include instructions for a personal information extraction task, a recently extracted personalized information template, a list of the personalized information to be extracted, constraints for extracting the personalized information, and session memory information.

The apparatus may further include a latest result memory management unit that summarizes question-response pairs for each session and stores the summarized question-response pairs in the latest result memory.

The latest result memory may store a session dialogue and a session dialogue summary composed of a plurality of question-response pairs for each session, and the latest result memory management unit ay generate a session summary prompt requesting to summarize a conversation of a specific session and input the generated session summary prompt to the generative language model, and store the response of the generative language model in the personalized information memory as a summary of a session dialogue of the corresponding session.

The session summary prompt may request to separately summarize a question set that collects multiple questions within a session and a response set that collects multiple responses within the session.

The apparatus may further include a personalized information editing unit that allows the user to edit the personalized information stored in the personalized information memory.

According to another embodiment of the present disclosure, a method of personalization of a generative language model includes: a step of storing personalized information of a user in a personalized information memory; and a personalized query generation step of generating a personalized query prompt including personalized information from a user query input by the user using the personalized information stored in the personalized information memory.

The method may further include: a step of storing question-response pairs for a predetermined period in a latest result memory; and a personalized information extraction step of extracting information utilized as the personalized information from the question-answer pair stored in the latest result memory and storing the extracted information in the personalized information memory.

The personalized information extraction step may include: a step of generating a personalized information extraction prompt requesting to extract the personalized information of the user based on information on a session conversation at predetermined cycles; a step of inputting a generated personalized information extraction prompt to the generative language model; and a step of storing a response of the generative language model in a personalized information memory as a personalized information template of the corresponding period.

The personalized information extraction prompt may include instructions for a personal information extraction task, a recently extracted personalized information template, a list of the personalized information to be extracted, constraints for extracting the personalized information, and session memory information.

The method may further include a latest result memory management step of summarizing question-response pairs for each session and storing the summarized question-response pairs in the latest result memory.

The latest result memory may store a session dialogue and a session dialogue summary composed of a plurality of question-response pairs for each session. The latest result memory management step may include: a step of generating a session summary prompt requesting to summarize a conversation of a specific session; a step of inputting the generated session summary prompt to the generative language model; and a step of storing the response of the generative language model in a personalized information memory as a summary of the session dialogue of the corresponding session.

The session summary prompt may request to separately summarize a question set that collects multiple questions within a session and a response set that collects multiple responses within the session.

The method may further include a personalized information editing step of allowing the user to edit the personalized information stored in the personalized information memory.

### BRIEF DESCRIPTION OF DRAWINGS

FIG. 1 is a functional block diagram illustrating a configuration of an apparatus for personalization of a generative language model according to an embodiment of the present disclosure.

FIG. 2 is a diagram illustrating generated results when a query that does not include personalized information is input to a commercial super-large language model.

FIG. 3 is a diagram illustrating generated results when a query that includes personalized information is input to the commercial super-large language model.

FIG. 4 is a diagram illustrating a structure of a latest result memory according to an embodiment of the present disclosure.

FIG. 5 is a diagram illustrating a dialogue pair in a session composed of multi-dialogue turns.

FIG. 6 is a flowchart illustrating a process of generating session dialogue summary information in an embodiment of the present disclosure.

FIG. 7 is a diagram illustrating an example of a prompt that requests to separately summarize a question set composed of k questions and a response set composed of k responses.

FIG. 8 is a diagram illustrating a configuration of a session dialogue and a session dialogue summary stored in a latest result memory.

FIG. 9 is a diagram illustrating a structure of a personalized information memory according to an embodiment of the present disclosure.

FIG. 10 is a flowchart illustrating a process of extracting personalized information according to an embodiment of the present disclosure.

FIG. 11 is a diagram an example of a personalized information extraction prompt.

FIG. 12 is a functional block diagram illustrating a configuration of an apparatus for personalization of a generative language model according to another embodiment of the present disclosure.

### DETAILED DESCRIPTION

The above-described aspect, and other aspects, advantages, and features of the present disclosure and methods accomplishing them will become apparent from the following detailed description of exemplary embodiments with reference to the accompanying drawings.

However, the present disclosure may be modified in many different forms and it should not be limited to the exemplary embodiments set forth herein, and only the following embodiments are provided to easily inform those of ordinary skill in the art to which the present disclosure pertains the objects, configurations, and effects of the present disclosure, and the scope of the present disclosure is defined by the description of the claims.

Meanwhile, terms used in the present specification are for explaining exemplary embodiments rather than limiting the present disclosure. Unless explicitly described to the contrary, a singular form includes a plural form in the present specification. The terms “comprise” and/or “comprising” as used herein do not exclude the existence or addition of one or more other components, steps, operations, and/or elements in addition to the mentioned components, steps, operations, and/or elements.

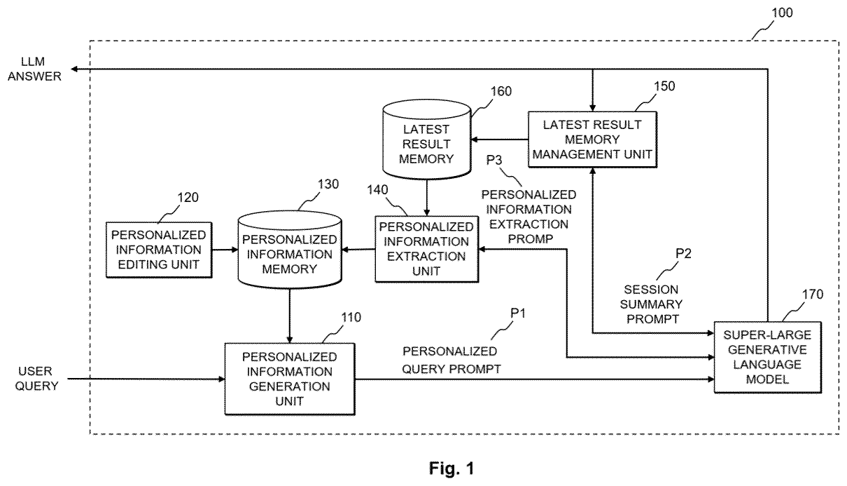

FIG. 1 is a functional block diagram illustrating a configuration of an apparatus for personalization of a generative language model according to an embodiment of the present disclosure. The apparatus 100 for personalization of a generative language model of FIG. 1 includes a personalized information memory 130 that stores personalized information of a user, a personalized query generation unit 110 that generates a personalized query prompt including personalized information from a user query input by a user using the personalized information stored in the personalized information memory 130, and a super-large generative language model 170 that generates an answer to the personalized query. The personalized information may be generated by a personalized information extraction unit 140 that extracts information that may be utilized as personalized information from a question-response pair stored in a latest result memory 160 that stores question-response pairs for a predetermined period, and may be stored in the personalized information memory 130. The apparatus 100 for personalization of a generative language model may further include a personalized information editing unit 120 that allows a user to edit personalized information stored in the personalized information memory 130. The apparatus 100 for personalization of a generative language model may further include a latest result memory management unit 150 that summarizes question-response pairs for each session and stores the summarized question-response pairs in the latest result memory 160.

The personalized query generation unit 110 generates a personalized query prompt P1 by adding the personalized information extracted from the personalized information memory 130 to a user query input by a user. The personalized information stored in the personalized information memory 130 is information that the user explicitly inputs through the personalized information editing unit 120 or extracts from the personalized information extraction unit 140 based on the latest result memory 160. The personalized information may include, for example, personal information such as the user's field of interest, preferred items, age, gender, and residence.

The personalized query generation unit 110 may extract personalized information related to the user query from the personalized information memory 130 and add the extracted personalized information to the user query. For example, when a user inputs “Recommend a place to travel in Seoul,” the personalized query generation unit 110 generates a personalized query prompt P1 with personalized information added, such as “Personal information: Age 50s, Gender: Male, Residence: Daejeon, Field of Interest: Cultural Heritage. Q: Recommend a place to travel in Seoul.”

The personalized query prompt P1 generated by the personalized query generation unit 110 is input to the super-large generative language model 170, and the super-large generative language model 170 generates a response that suits the user query by referring to the personalized information and presents the generated response to the user. The generated result is stored in the latest result memory 160 as the question-response pair along with the user query.

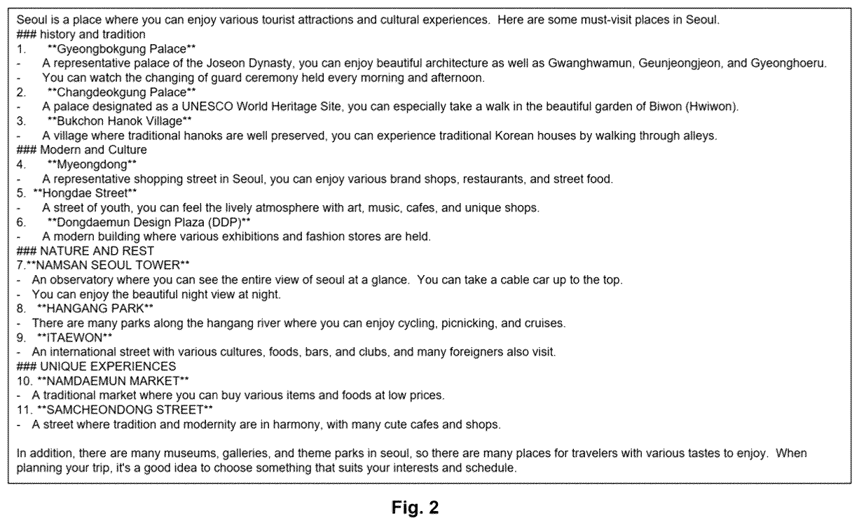

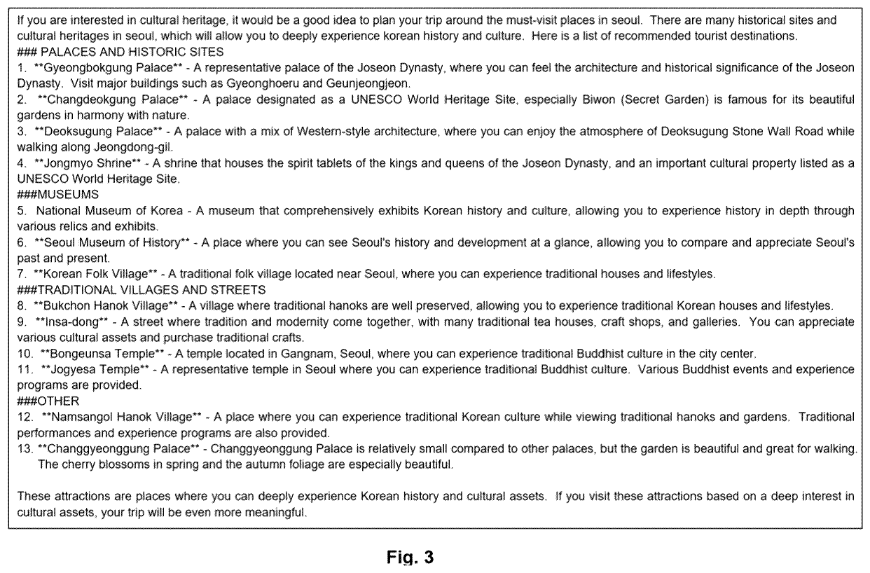

FIGS. 2 and 3 compare results of a query that does not include the personalized information and a query that includes the personalized information by inputting a commercial super-large language model (e.g., ChatGPT). FIG. 2 illustrates the generated results when “Recommend a place to travel in Seoul” is input. In FIG. 2, the generated results are categorized into “history and tradition,” “modern and culture,” “nature and relaxation,” and “unique experiences.” On the other hand, when personalized information such as “personal information age 50s, gender male, residence Daejeon, field of interest cultural assets” is added in front of the user query as illustrated in FIG. 3, the generated results are divided into categories such as “palaces and historical sites,” “museums,” “traditional villages and streets,” and “temples and shrines.”

In other words, by adding the user's personalized information to the query prompt, it can be confirmed that the results that suit the user's interests and situations are generated. Therefore, when the user may extract the personalized information from the history using the generative language model, the extracted personalized information may be automatically added to the user query to request the requested results from the super-large language model based on the personalized information, so results more suitable for the user's interests and situations may be expected.

The question and response information stored in the latest result memory 160 may be separately stored for each session of the question/response conversation. When the stored question-response pairs are accumulated to a certain extent, the personalized information extraction unit 140 extracts information that may be used as the personalized information from the stored question-response pairs and stores the extracted information in a personalized information memory 500. The personalized information extraction operation in the personalized information extraction unit 140 may be performed at a predetermined period or whenever a predetermined capacity is accumulated in the latest result memory. It is also possible to configure the user to set a period or condition for performing the personalized information extraction operation in the personalized information extraction unit 140.

When the process of the user editing the personalized information memory 130 through the personalized information editing unit 120 or the personalized information extraction unit 140 updating the personalized information in the personalized information memory 130 is repeated cyclically, the user's recent personal information and preference information are stored, and by requesting the results, which suit the recent personal information, from the generative language model, the user's personalized response results may be generated.

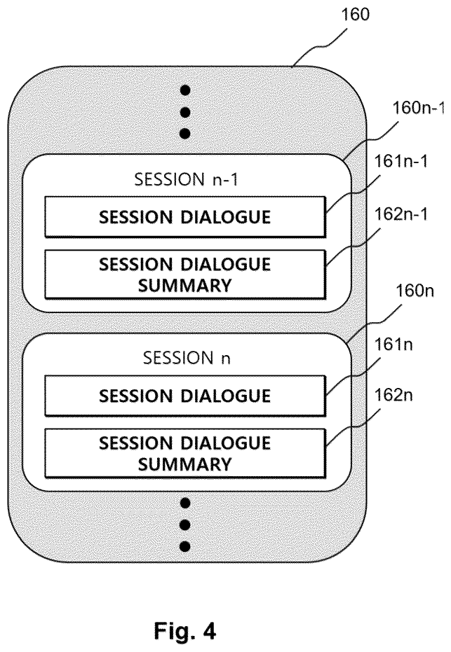

The structure of the latest result memory 160 according to an embodiment of the present disclosure is illustrated in FIG. 4. The latest result memory 160 is configured by session over time. Session-specific result information 160n-1 and 160n is composed of session dialogues 161n-1 and 161n and session dialogue summarizes 162n-1 and 162n which are composed of multiple question-response pairs within the session, and session dialogue summaries 162n-1 and 162n. That is, nth session result information 160n of the latest result memory 160 includes the session dialogue 161n and the session dialogue summary 162n.

Generally, when requesting information from the super-large language model, the user and the language model interact with each other to obtain the final information requested by the user. That is, each session Sn−1 and Sn is composed of multi-dialogue turns. There is a time interval between each session. For example, if the time when the conversation between the user and the language model is interrupted is longer than or equal to a predetermined time during the session, the current session is terminated, and a new session is started when the conversation between the user and the language model is resumed.

Most super-large language models utilize the history information in the session to generate results. The finally desired information is generally generated in a last conversation turn. This may be seen as a process of inference and concretization of thoughts to find information on a history of conversation turns that are performed to request the information desired by the user from the language model. Therefore, it can be seen that a method of searching for, by a user, information is implicitly expressed in the dialogue turn within the session. Summarizing the dialogue turn within the session is summarizing the process of inference and concretization of thoughts to search for information. In an embodiment of the present disclosure, the dialogue turn within the session is summarized and stored in the latest result memory 160.

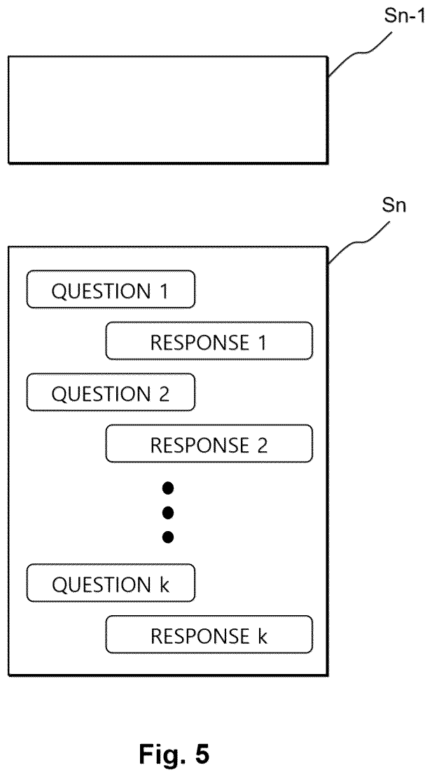

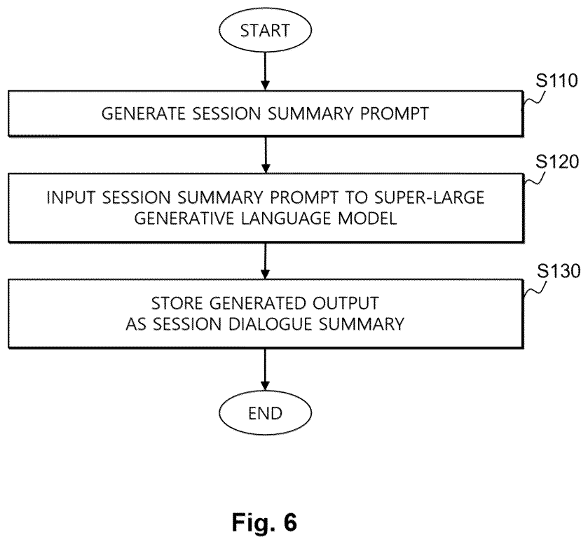

FIG. 6 illustrates the process of performing the session dialogue summary based on the dialogue turn between the user of session n and the super-large language model. In the following description, the case where session n (Sn) is composed of k questions and k responses as illustrated in FIG. 5 will be described as an example. That is, in FIG. 5, the session n (Sn) has k dialogue turns composed of question-response pairs.

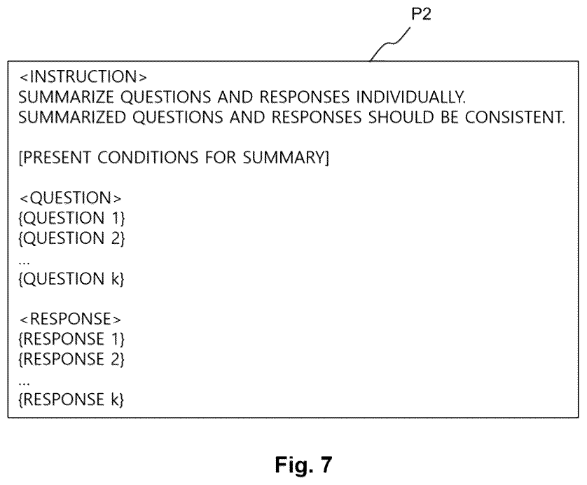

The latest result memory management unit 150 generates a session summary prompt P2 requesting to summarize a dialogue of a specific session (step S110). In an embodiment, the session summary prompt P2 may request to separately summarize a question set that collects multiple questions within the session and a response set that collects multiple responses within the session. An example of such a prompt is illustrated in FIG. 7. In the example of FIG. 7, the session summary prompt P2 is composed of instructions for a task, instructions for conditions for a summary, a set of questions, and a set of responses.

The latest result memory management unit 150 inputs the generated session summary prompt P2 to the super-large generative language model 170 (step S120). The latest result memory management unit 150 stores the response of the super-large generative language model 170 to the input session summary prompt P2 as the summary 162n of the session dialogue of session n (Sn) in the latest result memory 160 (step S130).

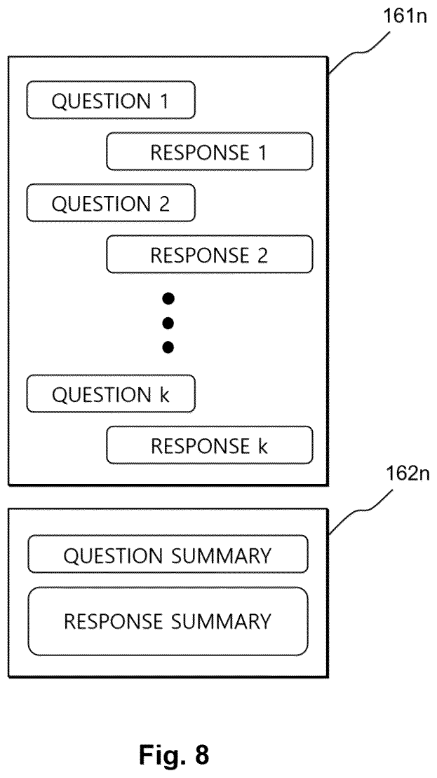

FIG. 8 illustrates one configuration example of the session dialogue 161n and the session dialogue summary 162n stored in the latest result memory 160. As illustrated in FIG. 8, k conversation turns composed of the question-response pairs of the session n (Sn) are stored as the session dialogue 161n in the latest result memory 160, and the summary of the session dialogue by the latest result memory management unit 150 is stored as the session dialogue summary 162n of the session n (Sn) in the latest result memory 160. Each session information generated in this manner is stored in chronological order to configure the latest result memory 160.

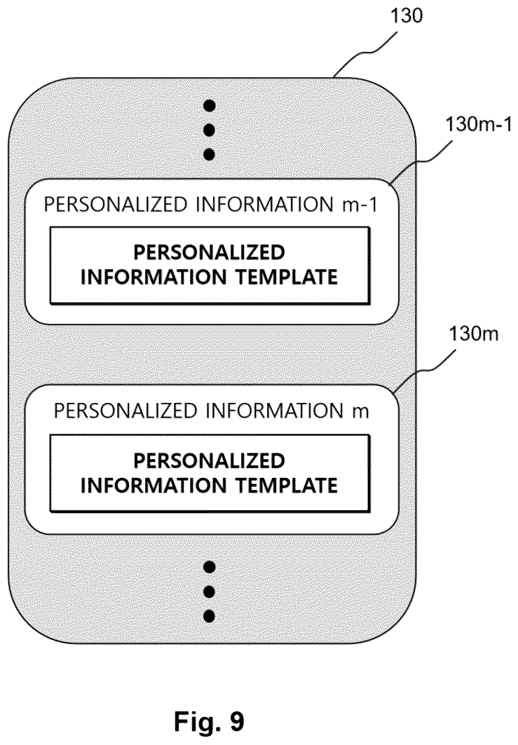

FIG. 9 is a diagram illustrating a structure of the personalized information memory 130 according to an embodiment of the present disclosure. The personalized information memory 130 stores the personalized information 130m-1 and 130m. The personalized information 130m-1 and 130m may be extracted and stored by set time period. That is, the personalized information is extracted from the session result information of the latest result memory 160 within the time range corresponding to the time period for each time period. For example, when the sessions within the time range corresponding to the time period for extracting the personalized information 130m are session n-1 (Sn-1) and session n (Sn), the personalized information is extracted from the session result information 160n-1 and 160n of the corresponding sessions.

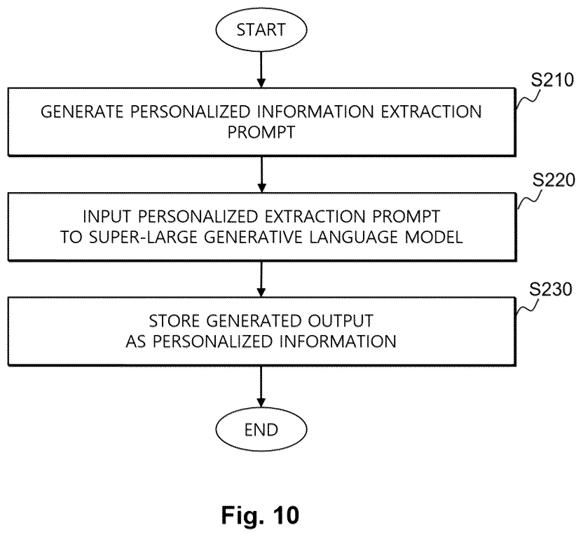

In an embodiment, the personalized information may be extracted by utilizing the super-large generative language model 170 based on the personalized information extraction prompt and the session memory information. FIG. 10 illustrates a process in which personalized information extraction unit 140 extracts the personalized information by utilizing the super-large generative language model 170 based on the personalized information extraction prompt and the session memory information.

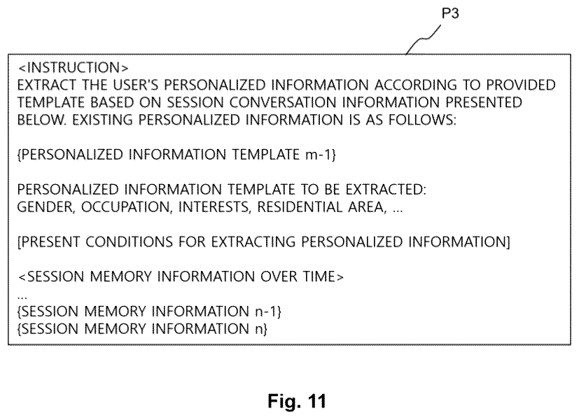

The personalized information extraction unit 140 generates a personalized information extraction prompt P3 that requests to extract the personalized information of the user based on information on a session conversation (step S210). In an embodiment, the personalized information extraction prompt P3 may request to extract the personalized information under conditions presented according to a personalized information template. An example of such a prompt is illustrated in FIG. 11. In an example of FIG. 11, the personalized information extraction prompt P3 includes instructions for a personal information extraction task, a recently extracted personalized information template, a list (template information) of personalized information to be extracted, constraints for extracting personalized information, and session memory information.

The personalized information extraction unit 140 inputs the generated personalized information extraction prompt P3 to the super-large generative language model 170 (step S220). The personalized information extraction unit 140 stores the response of the super-large generative language model 170 to the input personalized information extraction prompt P3 in the personalized information memory 130 as the personalized information template 130m of the corresponding period (step S230).

Meanwhile, the personalized information memory 130 may also be modified by the user using the personalized information editing unit 120. In particular, the initial personalized information may be input through an editing tool.

Based on the modules described above, as the user repeatedly uses the personalized super-large generative language model, the latest result memory and the personalized information memory are continuously updated, thereby generating the knowledge that better suits the user's personalized information. Through this, the super-large generative language model reflecting the personalized information is developed.

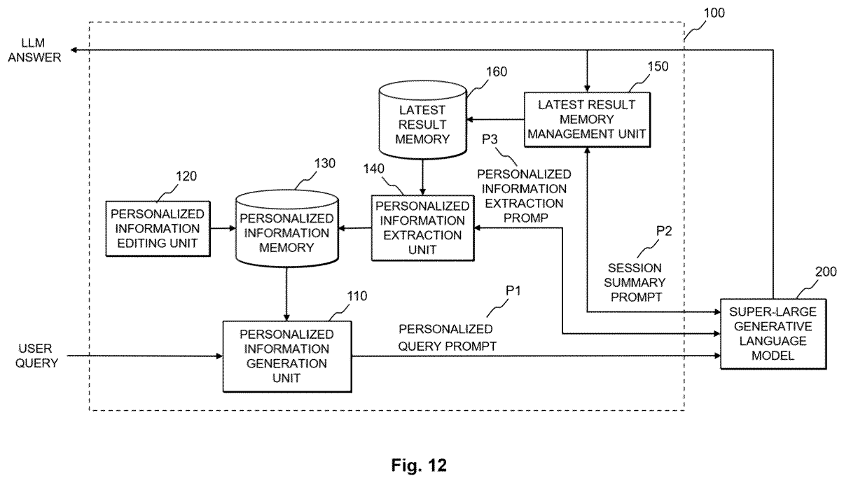

In the above description, the case where the super-large generative language model 170 is provided in the apparatus 100 for personalization of a generative language model was described as an example, but according to the embodiment, the apparatus 100 for personalization of a generative language model may be used by being connected to the external super-large generative language model 200 as illustrated in FIG. 12. In addition, although the above description describes the case where the personalized response is obtained from the super-large generative language model, the present disclosure can be applied not only to the super-large generative language model but also to a small language model, and the present disclosure is not limited to the specific language model. In addition, according to the embodiment, it is also possible to configure the personalized query prompt P1, the summary request prompt P2, or the personalized information extraction prompt P3 to be input to different generative language models.

The method according to the embodiment of the present disclosure may be implemented in a form of program instructions that may be executed through various computer means and may be recorded in a computer-readable recording medium.

The computer-readable recording medium may include program commands, data files, data structures or the like, alone or a combination thereof. The program instructions recorded in the computer-readable recording medium may be configured by being especially designed for the embodiment of the present disclosure, or may be used by being known to those skilled in the field of computer software. The computer-readable recording medium may include a hardware device configured to store and execute the program instructions. Examples of the computer-readable recording medium may include a magnetic medium such as a hard disk, a floppy disk, and a magnetic tape, an optical medium such as a compact disk read only memory (CD-ROM) or a digital versatile disk (DVD), a magneto-optical medium such as a floptical disk, a ROM, a RAM, a flash memory, or the like. Examples of the program instructions may include a high-level language code capable of being executed by a computer using an interpreter, or the like, as well as a machine language code made by a compiler.

According to an embodiment of the present disclosure, by supplementing the query prompt based on the personalized information for each user, it is possible to obtain the generated results that suit the user's field of interest or preference.

According to an embodiment of the present disclosure, by generating the personalized information using the generative language model from the question-response history with the user and supplementing the query prompt based on the generated personalized information, it is possible to obtain the generated results that better suit the user's field of interest or preference.

According to one embodiment of the present disclosure, by periodically updating the personalized information using the generative language model, it is possible to obtain the generated results that better suit the user's recent field of interests or preferences.

According to an embodiment of the present disclosure, by generating the session dialogue summary using a generative language model from the session dialogue with the user and extracting the personalized information using the generated session dialogue summary, it is possible to more accurately obtain the personalized information of the user.

The effects of the present disclosure are not limited to those mentioned above, and other effects not mentioned can be clearly understood by those skilled in the art from the following description.

Although embodiments of the present disclosure have been described in detail hereinabove, the scope of the present disclosure is not limited thereto, but may include several modifications and alterations made by those skilled in the art using a basic concept of the present disclosure as defined in the claims.

What is claimed is:

1. An apparatus for personalization of a generative language model, comprising:
a personalized information memory that stores personalized information of a user; and
a personalized query generation unit that generates a personalized query prompt including personalized information from a user query input by the user using the personalized information stored in the personalized information memory.

2. The apparatus of claim 1, further comprising:
a latest result memory that stores a question-response pair for a predetermined period; and
a personalized information extraction unit that extracts information utilized as the personalized information from the question-response pair stored in the latest result memory and stores the extracted information in the personalized information memory.

3. The apparatus of claim 2, wherein the personalized information extraction unit generates a personalized information extraction prompt requesting to extract the personalized information of the user based on information on a session conversation at predetermined cycles, inputs the personalized information extraction prompt into the generative language model, and stores the response of the generative language model in the personalized information memory as a personalized information template of the corresponding cycle.

4. The apparatus of claim 3, wherein the personalized information extraction prompt includes instructions for a personal information extraction task, a recently extracted personalized information template, a list of the personalized information to be extracted, constraints for extracting the personalized information, and session memory information.

5. The apparatus of claim 2, further comprising a latest result memory management unit that summarizes question-response pairs for each session and stores the summarized question-response pairs in the latest result memory.

6. The apparatus of claim 5, wherein the latest result memory stores a session dialogue and a session dialogue summary composed of a plurality of question-response pairs for each session, and
the latest result memory management unit generates a session summary prompt requesting to summarize a conversation of a specific session and inputs the generated session summary prompt to the generative language model, and stores the response of the generative language model in the personalized information memory as a summary of a session dialogue of the corresponding session.

7. The apparatus of claim 6, wherein the session summary prompt requests to separately summarize a question set that collects multiple questions within a session and a response set that collects multiple responses within the session.

8. The apparatus of claim 2, further comprising a personalized information editing unit that allows the user to edit the personalized information stored in the personalized information memory.

9. A method of personalization of a generative language model, comprising:
a step of storing personalized information of a user in a personalized information memory; and
a personalized query generation step of generating a personalized query prompt including personalized information from a user query input by the user using the personalized information stored in the personalized information memory.

10. The method of claim 9, further comprising:
a step of storing question-response pairs for a predetermined period in a latest result memory; and
a personalized information extraction step of extracting information utilized as the personalized information from the question-answer pair stored in the latest result memory and storing the extracted information in the personalized information memory.

11. The method of claim 10, wherein the personalized information extraction step includes:
a step of generating a personalized information extraction prompt requesting to extract the personalized information of the user based on information on a session conversation at predetermined cycles;
a step of inputting a generated personalized information extraction prompt to the generative language model; and
a step of storing a response of the generative language model in a personalized information memory as a personalized information template of the corresponding period.

12. The method of claim 11, wherein the personalized information extraction prompt includes instructions for a personal information extraction task, a recently extracted personalized information template, a list of the personalized information to be extracted, constraints for extracting the personalized information, and session memory information.

13. The method of claim 10, further comprising a latest result memory management step of summarizing question-response pairs for each session and storing the summarized question-response pairs in the latest result memory.

14. The method of claim 13, wherein the latest result memory stores a session dialogue and a session dialogue summary composed of a plurality of question-response pairs for each session, and
the latest result memory management step includes:
a step of generating a session summary prompt requesting to summarize a conversation of a specific session;
a step of inputting the generated session summary prompt to the generative language model; and
a step of storing the response of the generative language model in a personalized information memory as a summary of the session dialogue of the corresponding session.

15. The method of claim 14, wherein the session summary prompt requests to separately summarize a question set that collects multiple questions within a session and a response set that collects multiple responses within the session.

16. The method of claim 10, further comprising a personalized information editing step of allowing the user to edit the personalized information stored in the personalized information memory.
